(19) United States
(12) Patent Application Publication
(10) Pub. No.: US 2021/0387220 A1
(43) Pub. Date: Dec. 16, 2021

(54) PAINTING HEAD FOR MATERIAL SPRAYING DEVICE AND A METHOD FOR CONTROLLING THE SPRAYING DIRECTION OF THE DEVICE

(71) Applicant: TIKKURILA OYJ, Vantaa (FI)

(72) Inventor: Kalle SUORSA, Liminka (FI)

(73) Assignee: TIKKURILA OYJ, Vantaa (FI)

(21) Appl. No.: 17/291,128

(22) PCT Filed: Nov. 6, 2018
(86) PCT No.: PCT/FI2018/050814

§ 371 Date: May 4, 2021

(51) Int. Cl. B05B 12/12; B05B 13/04; B05B 15/652; B05B 13/00

(52) U.S. Cl. CPC B05B 12/12; B05B 13/005; B05B 15/652; B05B 13/0431

(57) ABSTRACT

The present invention introduces a painting head (403) for a spraying device, and a working tool module for a working tool. The device comprises two sensors, a gyroscope (301a) and an accelerometer (301b), for sensing positional and angular data of the painting head (403) or the working tool module. The controller (103, 305) calculates the desired relative angle of the painting head (403) in view of the longitudinal axis of the device so that when the user manually moves the device, the controller (103, 305) and the motors (104) automatically align the painting head (403) or the working tool module with a rotating movement in a substantially orthogonal direction towards the desired or treated surface (405) or towards the counter part element.

### BACKGROUND OF THE INVENTION

Paint spray guns are common tools for painting walls, ceilings, objects or other kinds of surfaces which are large or difficult to approach directly. Similar kinds of devices can be used in cleaning purposes when the liquid sprayable matter is water or cleansing substance, and high pressure is used to spray the liquid material onto a desired surface. Also some working tools or remote measurement devices have common characteristics with paint spray guns in the sense that a certain distance to the wall or other surface is desired. Paint spray tools usually have an arm section whose length is fixed, and which arm section has a handle in its other end for manual grabbing of the device, allowing the user to reach more distant areas from the painter's point of view. A paint spray gun may include one or several nozzles in the other end of the arm section for outputting the paint or other liquid substance. With a plurality of nozzles lined in an orthogonal direction in relation to the movement direction of the spraying device, the user obtains a wider painting area with a single brushing movement.

Especially in painting walls, ceilings and roofs, there emerges a need to use longer arms, cranes or tools in order to reach the surfaces to be painted which locate farther from the painter him/herself. The longer the distance between the paint spray gun user and the surface to be painted, the bigger is the possibility for non-accuracy during the painting process.

In prior art, the paint spray guns with longer arms may use a fixed structure where the arm and the paint nozzles locate in a fixed mutual alignment angle. Such a construction of the spray gun with a longer arm results in that when painting e.g. a higher wall along a vertical movement of the spray gun, the paint output direction from the nozzles is different in the lower part of the wall compared to the higher part of the wall. Even a variable length arm, where the arm length could be changed by a motor, would easily result in a changing paint output direction towards the surface to be painted, and therefore the painting quality could easily get worse. The structure with a fixed mutual alignment angle between the arm direction and the nozzle direction results in the fact that only a single height level has an optimal (i.e. orthogonal) painting direction. Such a device is not practical.

In some prior art solutions, the nozzle direction could be mechanically or manually changed by rotating the nozzle around a joint, with the nozzle achieving a new angle in relation to the arm supporting the nozzle. The manual and mechanical adjustment is pretty inefficient, and requires a lot of manual work besides the actual painting process which also takes time.

It can be said that alternative traditional solutions in the field of painting devices comprise manual solutions where no intelligence is built in the device for measuring distance or angular parameters and controlling the device based on these measurements.

Prior art devices may have movement controlling intelligence in the device itself, and an example of such a device has been presented in PCT publication “WO 2016/009112” (i.e. “Vahanen 1”). This painting device comprises at least two sensors for detecting location, alignment and movement status of the painting head, and these sensors can be selected from a group of gyroscope, accelerometer and magnetometer. Furthermore, a distance detection sensor is used to measure the distance between the painting head and the closest surface to be painted. The distance detection may be implemented by a laser light transmission and reception or with an ultrasound transmission and reception, both based on reflection from the surface to be painted. A user interface (buttons, joystick, handle) is available for manual commands made by the user, including switching the device on/off and selecting “a forced painting mode”. A retractable arm can be used to tune the length of the painting arm. Vahanen 1 has a possibility to rotate the painting head (with the nozzle) around three different axial directions; X-, Y- and Z-axis directions. Vahanen 1 automatically tunes the painting head alignment angle when the painting device (the painting head) is moved along a surface to be painted e.g. by a stationary user. Thus, Vahanen 1 is a distinguished device with an intelligently controllable painting head.

Other aspects of Vahanen 1 comprise a pressurized washing device using an arm structure with a high-pressure water or other cleaning liquid to be sprayed onto a material. A further aspect is a working tool which works like a remotely controllable machine-directed screwdriver. A physical contact between a tool module and a counterpart element is thus required in this application.

It can be said that the distance detection sensor assists in finding two target distances depending on the used aspect of Vahanen 1: an optimal painting distance in the painting device application (which can be considered as a fixed distance value), and the contact situation (i.e. distance=0) in the working tool application between the tool and the counterpart. Of course, the device may have other distances from the surface because of the manual use situation, but the system tries to actively reach these target distances.

An angle locking feature is possible in Vahanen 1 by selecting through the user interface, for instance in fixing the painting head angle for a given time duration when passing a barrier, step or other kind of discontinuation in the painted surface.

Furthermore, a centralized controller unit in Vahanen 1 handles all sensor data and performs required calculations, taking also into account user input signals, and finally feeding the commands to the motors of the device. Also a screen can be added to the device of Vahanen 1 in order to show status information of the device and e.g. sensor data to the operator of the device.

Different surfaces to be painted and different locations of the surfaces in view of the human user make painting situations various. Also the painting process is desired to be controlled in a more human-controllable manner than just by keeping the distance to the painted surface correct. These issues are not handled that much in Vahanen 1.

Thus, there is a need to introduce an even more intelligent and highly practical paint spraying device where these different circumstances and locations are taken into account in using the device in an effective manner.

### SUMMARY OF THE INVENTION

The present invention introduces a painting or washing or spraying device configurable to spray liquid material, wherein the device comprises a device housing, which is holdable manually by a user or configurable on a fixed or movable platform, a painting head, and a controller.

The device is characterized in that it further comprises a gyroscope and an accelerometer in connection with the painting head for sensing the positional and angular data of the painting head, wherein during movement of the device, the controller is configured to adjust the angular alignment of the painting head in relation to the device housing so that the painting head is directed substantially orthogonally to a treated surface, allowing an optimum incoming direction for the liquid material in view of the treated surface.

In an embodiment of the invention, the device further comprises user input means configured to give the user the functions of starting or stopping the liquid material flow, a selection of an operational mode, and/or to adjust arm lengths of retractable arms.

In an embodiment of the invention, the adjustment of the angular alignment of the painting head is obtained by rotating the painting head around three axes which are mutually orthogonal.

In an embodiment of the invention, the rotating movement around the axes or axis is obtained by at least one motor.

In an embodiment of the invention, the device is configured to sense the movement, alignment and position information of the painting head with the gyroscope and the accelerometer, to calculate the painting head angle in relation to the device housing or arm based on sensed information and possible operational mode in the controller, and to rotate at least one motor in order to obtain a substantially orthogonal direction of the painting head towards the surface to be treated.

In an embodiment of the invention, the device is a manually usable device through a gripping part, a device attachable on a crane or a drone or a vehicle, or a device implemented in a robotic arm.

According to a second aspect of the same invention, it comprises a working tool configurable to work with a counterpart element or with a desired surface, wherein the working tool comprises an arm or a device housing, which is holdable manually by a user or configurable on a fixed or movable platform, a working tool module, and a controller.

The working tool is characterized in that it further comprises a gyroscope and an accelerometer in connection with the working tool module for sensing the positional and angular data of the working tool module, wherein during set-up of the working tool towards the counterpart element or towards the desired surface, the controller is configured to adjust the angular alignment of the working tool module in relation to the arm or device housing so that the working tool module is directed substantially orthogonally to the counterpart element or to the plane of the desired surface.

According to a third aspect of the same invention, it comprises a method for controlling a painting or washing or spraying device or a working tool. The controlling method is characterized in that it comprises the steps of:
sensing the positional and angular data of a painting head or a working tool module by a gyroscope and an accelerometer, which are located in connection with the painting head or a working tool module,
adjusting the angular alignment of the painting head or a working tool module in relation to the device housing by a controller during movement of the device or working tool so that
directing the painting head or the working tool module substantially orthogonally to the plane of the treated or desired surface or to a counterpart element.

### BRIEF DESCRIPTION OF THE DRAWINGS

FIG. 1 illustrates general parts required in controlling a paint spraying device according to the present invention,

FIG. 2 illustrates the physical design of a painting head of the spraying device according to one embodiment of the invention,

FIG. 3 illustrates physical elements and applied method steps as a flow chart, and

FIG. 4 illustrates an example of a use position of the painting device.

### DETAILED DESCRIPTION OF THE INVENTION

The present invention introduces a paint spray gun or a spraying device configured to spray also other liquid material than paint (like water or any cleaning substance or a mixture of them, or fluid gel-type material), where a painting head can be controlled and adjusted intelligently by using certain sensors in the painting head. In a main embodiment, paint can be sprayed from the spray gun or spraying device. The inventive idea can also be extended to a working tool. The necessary elements needed for proper controlling of the painting head are fewer than in reference “Vahanen 1”. This is the main advantage of the invention, thus making it also cheaper to manufacture than Vahanen 1.

In an embodiment of the invention, the spraying device has a controlling method for automatic movements and alignments of the spraying end of the device. The painting head can also be called as a spraying end of the device, and it comprises one or more nozzles. The spraying device comprises a controller and two different sensors for detecting location and movement status of the painting head, and also for detecting alignment status (angular pointing direction) of the painting head (i.e. of the nozzle(s)). The spraying device also comprises a user interface allowing user input commands. The user interface can be a touch screen or it can be formed by at least one button, keyboard, switch or other kinds of input means like a joystick. The user interface may locate near the gripping part of the painting device for easy manual access by the user.

In an embodiment of the invention, there are two sensors in the painting head of the present invention. The selected two sensors in a preferred embodiment are a gyroscope and an accelerometer. The gyroscope measures orientation of the painting head, and the accelerometer senses the acceleration of the painting head. From the acceleration information as a function of time, also velocity information can be obtained if the starting velocity (or reference velocity) is known (Δv=a*Δt). Furthermore, from the velocity information as a function of time, the location information can be obtained (Δs=v*Δt).

We next refer to the drawings which illustrate the basic principle of the present invention.

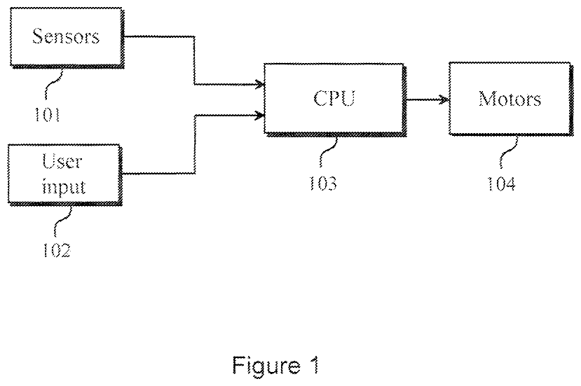

FIG. 1 illustrates the main components needed in the implementation of the intelligent controlling of the painting head according to the present invention. Sensors 101 are required in the painting head for detecting movement status, movement direction and angular directional information regarding the painting head. Because the at least one nozzle is fixed to the painting head and it is an integral part of the painting head, these parameters of the painting head correspond to the speed, location and alignment information of the nozzle(s) as well. In a preferred embodiment of the present invention, a gyroscope and an accelerometer are used as fixed to the painting head.

Secondly, user input from the human user of the spraying device is enabled by having at least one type of user input means 102 on the device or in connection with the device. In case the spraying device is a mobile hand-held device comprising a handle, and possibly an arm between the nozzle(s) and the handle, the user input means can be placed near the handle, pointing towards the user when holding the device in the hand of the user. In case the spraying device is connected to a crane, a drone or a vehicle or a robot with a possible arm structure, the user input means can be implemented e.g. in a control panel reachable by the user. Of course, the user input can also be implemented in an external location, such as in a control room, and the control signals can be transmitted to the painting location and to the controller (i.e. the processor, or the CPU) of the spraying device through data transmission means. It can be implemented as wired or wireless communication means. This application means that proper visual inspection means is available for the remote controlling and user input feeding from an external location, such as video imagery on the painting site.

The input information from the painting head (by sensors 101) and the user (by user input 102) are then fed to the central processing unit (CPU, i.e. the controller) 103 which performs the data handling, data calculations and processing steps, and finally gives commands in its output port. The calculations are discussed in detail elsewhere in the application text.

In one embodiment, it is possible that a part or all of the calculations are implemented in an external location, such as a cloud server or an external PC. In that case there are the data transmission means in the spraying device for transmitting and receiving data between the spraying device and the external calculation means. It can be implemented as a wired connection or as a wireless connection, as mentioned earlier.

The output commands comprising control signals for the painting head movements are fed from the CPU 103 to a group of motors 104 (i.e. comprising at least one motor). The motors 104 will enable the rotation and/or movement of the painting head to a desired location and pointing to a desired alignment angle. In one embodiment of the invention, the motors 104 comprise three motors each rotating along one of the X-, Y- or Z-axes. The arm structure can have a structure where subsequent joints comprise one motor per each joint, and each joint is rotatable according to the input signal from the CPU 103. Thus, the painting head with the nozzle(s) can be aligned in any desired direction in view of the painted surface, and also in any specified distance from the surface to be painted.

The working tool application is part of the inventive concept as well.

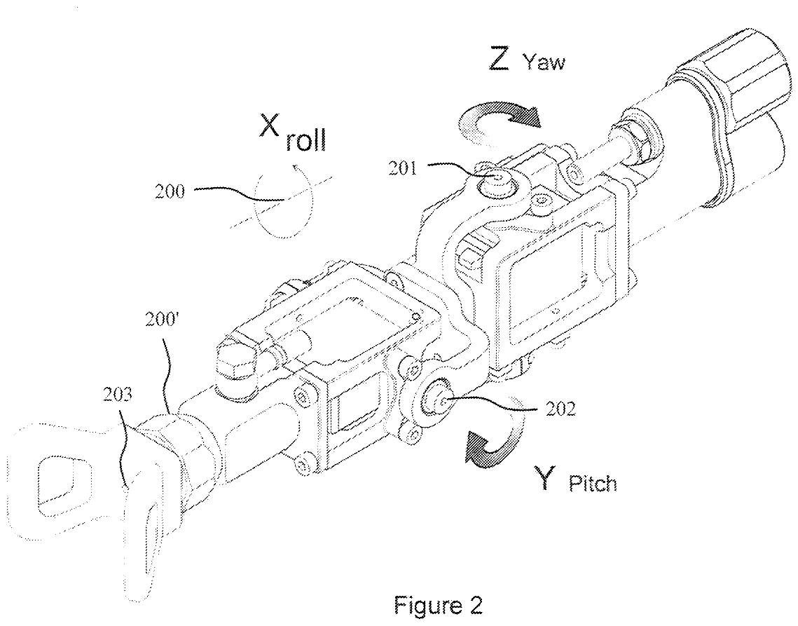

FIG. 2 illustrates a painting head structure according to a preferred embodiment of the present invention. This embodiment shows a possible outer shape of the painting head. More importantly, the painting head is rotatable around three axis: the longitudinal axis 200 represented by Xᵣₒₗₗ, the vertical axis 201 represented by Z_{Yaw} and horizontal (also orthogonal to the arm) axis 202 presented by Y_{Pitch}. The joint location for Xᵣₒₗₗ is in this example between the rotatable vertical axis 201 and rotatable horizontal axis 202 (in the middle of the device, as unmarked). Alternatively, the rotatable axes can be selected to locate differently along the device; e.g. by enabling the Xᵣₒₗₗ rotation by rolling just the element 200′ and the outputting nozzle 203 in relation to the rest of the device. While the user can manually place and point the painting head to a desired location and alignment angle (combined with the stance location of the user), the automatically adjusting intelligent control of the painting head is obtained by intrinsic sensor information, and rotating the painting head around the rotatable joints according to the executed calculations. In a preferred embodiment, during the active operation of the painting device, the painting head will point substantially orthogonally to the nearest surface which is to be painted. With active operation, it is meant the situation, when the paint or other applicable liquid is sprayed out from the nozzle(s) of the painting head. This idea can be enlarged to cover the working tool as well, in the sense that the active operation can mean both the working tool contact with the counterpart element or surface, but also the closing movement onto the counterpart element or to the surface. In other words, the working tool will close in to the counterpart element in an orthogonal alignment angle, when the user manually directs the working tool by his/her hands.

In the example of FIG. 2, the outputting nozzle 203 for the paint or liquid is the small hole in the center of the lefthand-most element (in the jaw-shaped end element). In the righthand-side of the shown design, there can be an arm section, which may comprise several interconnected arms or retractable arms. In the other end of the arm structure, a gripping part for the painting device is attached.

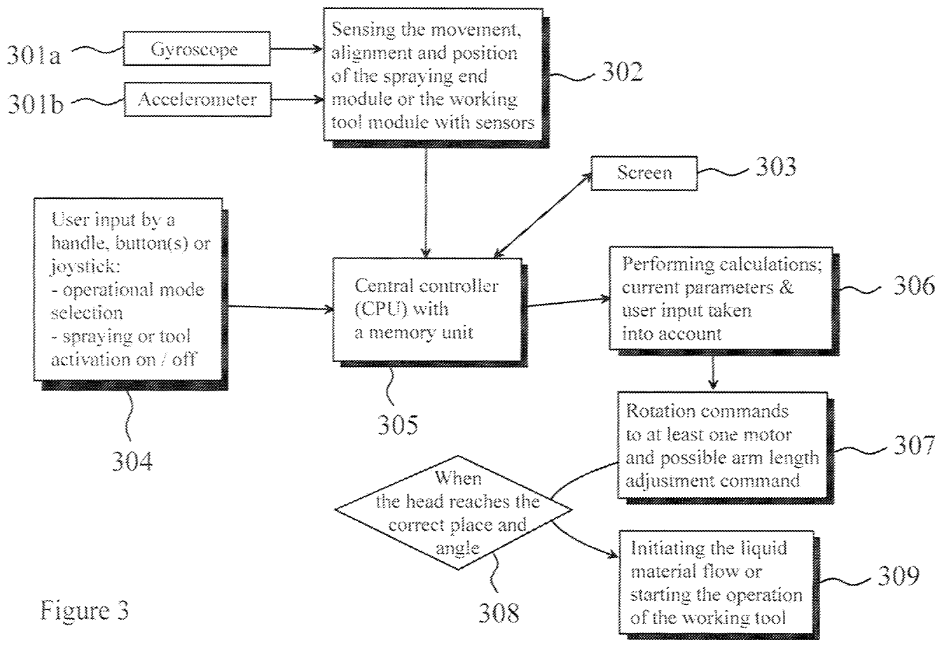

FIG. 3 illustrates physical elements and applied method steps as a flow chart. In other words, it illustrates the process of intelligent controlling of the paint spraying device, a pressure washer, a liquid transport system, or a working tool module. At first, the sensors 301a-b fixed or connected on the spraying end module (like e.g. a painting head) or on the working tool module measure a current position (absolute coordinates), its alignment data (nozzle head or tool head angle) and movement (speed and/or acceleration of the spraying end module or the working tool module) in step 302. The exemplary sensors to be used are a gyroscope 301a for measuring orientation of the end module, and an accelerometer 301b for measuring its acceleration (and using the equations a=Δv/Δt and v=Δs/Δt; achieving the movement data along three different axes). All sensed and measured information can be saved to the memory unit and thus fed to the calculation logic of the system, i.e. to a central controller 305 (“CPU”, or other kind of a data processing unit). User input 304 commands are given with specific means (such as e.g. a handle, button(s) or joystick) available manually to the user and the user input signals are fed to the central controller 305 as well. The user input 304 commands comprise an operational mode selection, and further, the user may enable the spraying action or tool activation to be on or off. The operational mode may be a wall operational mode, a ceiling operational mode and a holding mode. The first two operational modes keep the alignment angle at substantially orthogonal direction in view of the wall or ceiling, while the holding mode keeps the alignment angle of the painting head as fixed, no matter how the painting device is moved. When the spraying action or tool activation is on, the device will automatically spray the liquid or rotate the screw, when the correct distance and alignment is reached for the painting head or working tool module after the intelligent tuning of the painting head position and alignment. Alternatively, this on/off button (or other means) can be used as a “dead man's switch”, where the device sprays the liquid or rotates the screw only when the on/off-button is pressed by the user. The device may have a screen 303 which acts as device output interface to the user. In an embodiment, the user input 304 means can be implemented as a touch screen, which then integrates the functionalities of elements 303 and 304.

Apart from the manual signals given by the user, the painting head has automated position and alignment tuning based on measured information through the sensors 301a-b. The central computer or controller 305 then calculates magnitude and direction of a required correction to the current location and angle of the device's painting head (or the working tool module). If there is a need for correcting the painting head location or alignment, the central controller 305 will calculate a required change or compensation 306 needed for the painting head location and its angle. The sensor data achieved from the sensors 301a-301b may be fed to a Kalman filter which can handle non-idealities in the form of noise in the sensor data, and also recursively it can take the previous sensor results into analysis when estimating the following state (location and angle) of the system. Different sensors can be weighed with various and selectable coefficients in the calculations. The calculation algorithms for the absolute location, angle and distance to the closest object can be implemented as a single software block or by several separate computer program code scripts available in the memory unit and executed by the controller. When the compensation results are ready, this information is triggered into rotation commands 307 for the motor or motors. The command signals can be fed simultaneously to the motors, and the motor rotation movements can be simultaneously triggered for quick realization of the painting head correction. The arm lengths can be adjusted as well if the joints between the arm sections are motorized.

If desired, the system may rely on single calculation round during correcting the position and alignment of the painting head. Still, in another embodiment, it is possible to re-measure the new device environment with the two different sensors 301a-301b after making a correction movement through rotation by at least one motor. The newly sensed information may be used in refining the correction magnitude (for both the position and the angle) and therefore, the correction can be made even better regarding the achieved accuracy.

The condition 308 regarding reaching the correct place and achieving the correct and desired angle of the painting head towards the closest surface is fulfilled when the rotation orders have been implemented and each motor has concluded its movement. The desired angle is substantially 90 degrees in relation to the surface to be painted (e.g. to a wall or to a ceiling).

The operation of the motors can be selected wisely so that in case of extremely narrow spaces to be reached, the motors can be operated sequentially in a way where no collision happens with an obstacle. It may be beneficial to e.g. first operate the arm length motor with a protruding movement (increasing the arm length) and after that, to progress with the three motors capable of finding the right angle towards the painted surface.

When the correction movement has been finished, the central controller 305 will in one embodiment trigger the initiation 309 of the fluid transport towards the painting head and out towards the surface (wall or ceiling), where the effect of the liquid is desired. Regarding the working tool operation embodiment, this step will initiate the operation like starting the rotation of the screwdriver head in a desired rotational direction. In another embodiment, the initiation of the liquid flow or the rotation of the working tool module can be done manually (e.g. through the on/off switch pressable by the user). In the latter case, also stopping of the liquid flow or stopping of the working tool module rotation can be performed manually (e.g. by releasing the on/off switch).

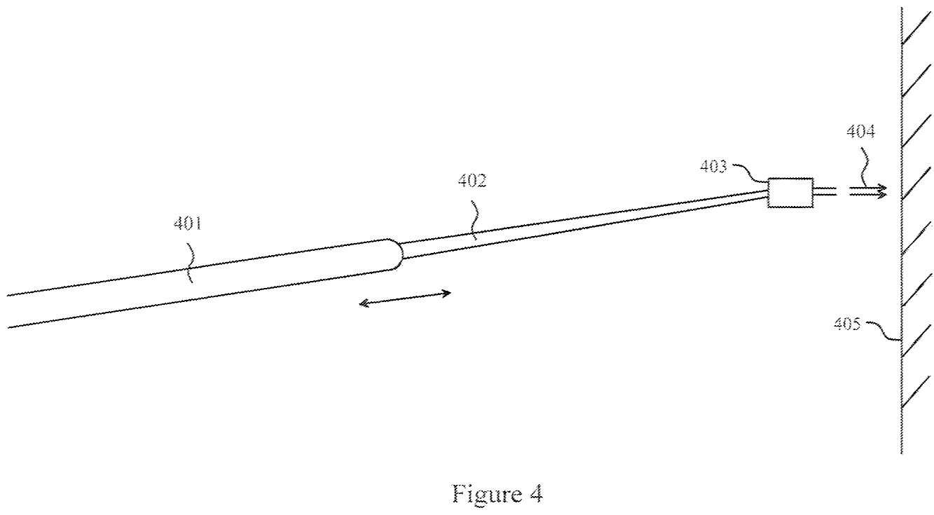

FIG. 4 illustrates an example of a use position of the painting device. This can be called as an example of an operating mode, which in this case is “wall”. This means that the surface to be painted is in practice a vertically aligned planar surface, i.e. a vertical wall 405. Of course, in some special embodiments, the wall to be painted can be oriented in a tilted fashion, but it is unusual in regular painting situations. With a “normal” vertically aligned wall 405, depending on the horizontal location difference between the device user (i.e. the stance location) and painted location (i.e. the location where the paint 404 hits and adheres to the wall 405) and also depending on the height of the painted location from the floor level, the alignment angle of the painting device arm 401-402 can be determined, taking also account that a certain horizontal distance needs to be present between the nozzle and the painted location on the wall. If the painting head (comprising the nozzle(s)) would be fixed to the end of the arm as a fully integrated and non-rotatable element, its spraying angle would be always the same with the alignment angle of the arm. However, in the present invention, the painting head 403 direction (i.e. the nozzle direction) in relation to the arm 402 direction can be tuned by using the motor or motors. One example of the geometry is depicted in FIG. 4. The main feature in the wall painting mode is that the painting head 403 is pointed substantially orthogonally to the plane of the wall 405 to be painted, when the paint 404 is output from the painting head 403. There are some physical, mainly mechanical, restrictions in changing the painting head 403 angle in relation to the arm 402 direction. In one example, the maximum angles can be 70 degrees to all directions, meaning that the painting head 403 is able to turn from −70 degrees to 70 degrees from left to right, and from −70 degrees to 70 degrees from downwards to upwards direction (in view of the arm 402 direction=0 degrees). This means that if the painter positions him/herself at some suitable distance from the wall 405 to be painted, he/she is able to cover much larger surface area from a stationary standpoint than with a fixed painting head direction. This is a clear advantage of such an automatically adjustable painting head 403. Of course, the 70 degrees' choice is merely a single example, and many other maximum angular values are physically and mechanically possible in the device. In one embodiment, the mechanical limit can be −90 degrees . . . 90 degrees, meaning that the user standpoint may even locate directly beneath the painting head 403, at the same distance from the wall 405 than the distance of the painting head 403 from the wall 405.

In all the embodiments, paint can be replaced with water, other liquid, or liquid-based material (such as a gel, or a liquid solution comprising solid particles) which is capable of flowing and to be sprayed on any desired place or surface, or just outwards from the nozzle working as the end module output (i.e. as the painting head). Such a place where the sprayed liquid material is directed to, may thus also be air or even a vacuum, like the way a fountain works. The liquid material to be sprayed could even be replaced by some solid material, e.g. like small rocks, crushed gravel or sand used in a sanding machine in freezing or other circumstances where friction to the ground needs to be increased. Another possible example of a solid material to be sprayed is a snow making machine used in downhill skiing centers, or a tennis ball cannon used for consistent ball hitting during a tennis practice session.

In yet another possible option, the device may be configured to spray gaseous materials, such as e.g. air, from its nozzles.

In an embodiment of the apparatus, a centralized controller unit handles gathering of the sensor information, required calculations, handling user input signals, and giving commands to the motors through the wirings inside the arm structure. The controller unit may be physically located near the handle of the spraying device. A different way of implementing the controller is using a wireless transceiver in the spraying device, and operating the spraying device externally through a remotely located computer. In such an embodiment, the microprocessor of the computer or server works as a controller as mentioned in the above.

With an external computer which performs calculations and commands to the spraying device, it is possible for control the painting or washing process from a suitable interior like inside the building whose ceiling is being treated on the outside, or from a vehicle used by the service provider which may be parked in a close vicinity of the treated surface.

As a useful tool for any user handling or operating the spraying device in practice, the device itself may be provided with a screen capable of showing various apparatus information, sensor data, or any other kind of application data to the user or the operator of the spraying device. The information may include device status information and alarm data as well. The screen can be attached in close proximity to the operator's (i.e. user's) handle of the device. Another option for showing the application or device parameters to the user is to present the information on the screen of the remotely locating computer or server. In one embodiment of the invention, the screen may be used as a user input interface as well through touch screen functionalities.

The device naturally requires electrical supply power in some form. This may be achieved through a battery or set of batteries fixed to an appropriate battery holding space of the device or through mains current input onto which the spraying device is connected. When the mains current is connected to the device, the less than fully charged battery can then be loaded simultaneously.

Similarly as the electrical supply, the device needs a main material input bus like a paint input pipe connected with a sufficiently large paint storage volume, or a water pipe together with a connection to a water tank or water supply. For situations where the main material input flow needs to be interrupted for some reason, like in an especially tight area where the painting is performed, there can be provided a smaller reserve material tank connected to the spraying device. This can be also called as an intermediate tank. When there is any need to cut the connection to the main input pipe coming from the paint or water storage, the reserve tank will be switched on, and the most difficult spaces, for instance, could be painted without any restrictive input hoses or pipes connected to the spraying device. The system can be provided with a compressor which provides a needed pressure level when the battery supply is used as the input power. In one embodiment, the reserve material tank may have a volume between 1 litre to 10 litres, and it can be fixed directly to the device near its gripping part. Another exemplary option is to set the reserve material tank and the compressor in a backpack which is carried by the user of the device.

The present invention is generally suitable for various liquid transport systems where the location and the angular direction of the transport system's output is required to be tracked or directed for any reason. Another possible application area is to use the invention with a specific tool, e.g. with a machine-directed screwdriver or in other kinds of utensils or instruments which may have a specifically shaped arm or head for grabbing or processing any material or object. The screwdriver application is a useful one because the exact placement of the tool's head and also the alignment direction onto the screw is essential for the tool to be successfully used. Also, the locations and the face directions can be tricky regarding the accessibility to the site itself. The present invention allows any tool with a controllable processing or grabbing head to be used remotely with or without a specific arm, giving access to places not otherwise easily accessible to be worked with. With the present invention, working tools may be used successfully without extensive cranes or support structures required on the scene.

The controlling of the painting device and the working tool is performed by the controller, which executes the commands and intelligent tuning of the device head through a computer program. The computer program can be saved in a memory of the painting device or a working tool. Alternatively, the computer program can be downloaded to be executed by the controller from an external location, such as an external server or PC, or from a cloud computing service. The manual commands from the user are fed to the controller as well, giving appropriate control commands based on intelligent measurements and the user commands. The control commands may affect the lengths of the arms 401-402 of the device, the intelligent direction control of the painting head 403 or a working tool module, and the active time periods, when the paint 404 or liquid is sprayed on the desired surface, or when the working tool module is set to e.g. rotate the screw on the wall. This idea of course comprises other possible manners of working or acting on the counterpart or the desired surface with the working tool module.

Generally speaking, the present invention is useful for correcting any movement error or vibration or mistakes in painting or washing processes. A second benefit is that during painting larger surfaces like high and large wall surfaces, the prior art solution like painting devices with a fixed-angle nozzle will result in varying arrival angles for the paint or water in relation to the affected surface. With the present invention with an intelligent location and angle tuning system for the end module (the painting head), the arrival angle of the paint towards the surface can be tuned intelligently to substantially orthogonal direction in view of the painted surface. This enhances the paint adhesion and the overall quality of the painting dramatically. Regarding any tool head operation remotely with the principles of the invention, much easier access to the operated location may be achieved without specific cranes or support structures which would have to otherwise be built for the tool operator him/herself. A further advantage is the possibility to make the device more portable and movable in smaller spaces, when the local battery is used as the power supply and the smaller reserve paint or water tank is locally taken into use.

A main advantage over Vahanen 1 is that the present invention works fully with just using two sensors; a gyroscope 301a and an accelerometer 301b.

A further option for the invention is to use it with industrial robots, like on a production line of a factory with automatically operated arms. The intelligent sensing and movement control of the device head module is directly applicable to situations where industrial robots are used in manufacturing of the devices, like in assembling and painting new cars. This is an advantageous application area as well for the present invention.

A machined screwdriver operation in difficult locations is an example of the invention in the area of working tools. The present invention has the advantage that difficult or even impossible locations for manual screwdriver use can be overcome with the working tool according to the present invention.

The present invention is not restricted merely to the embodiments disclosed above, but the scope of the present invention is defined by the claims.

1. A painting or washing or spraying device configurable to spray liquid material, wherein the device comprises
a device housing, which is holdable manually by a user or configurable on a fixed or movable platform,
a painting head, and
a controller,
wherein the device further comprises
a gyroscope and an accelerometer in connection with the painting head for sensing the positional and angular data of the painting head,
wherein during movement of the device, the controller is configured to adjust the angular alignment of the painting head in relation to the device housing so that
the painting head is directed substantially orthogonally to a treated surface, allowing an optimum incoming direction for the liquid material in view of the treated surface.

2. The device according to claim 1, further comprising user input means configured to give the user the functions of starting or stopping the liquid material flow, a selection of an operational mode, and/or to adjust arm lengths of retractable arms.

3. The device according to claim 1, wherein the adjustment of the angular alignment of the painting head is obtained by rotating the painting head around three axes which are mutually orthogonal.

4. The device according to claim 1, wherein the rotating movement around the axes or axis is obtained by at least one motor.

5. The device according to claim 1, wherein the device is configured to sense the movement, alignment and position information of the painting head with the gyroscope and the accelerometer, to calculate the painting head angle in relation to the device housing or arm based on sensed information and possible operational mode in the controller, and to rotate at least one motor in order to obtain a substantially orthogonal direction of the painting head towards the surface to be treated.

6. The device according to claim 1, wherein the device is a manually usable device through a gripping part, a device attachable on a crane or a drone or a vehicle, or a device implemented in a robotic arm.

7. A working tool configurable to work with a counterpart element or with a desired surface, wherein the working tool comprises:
an arm or a device housing, which is holdable manually by a user or configurable on a fixed or movable platform,
a working tool module, and
a controller,
the working tool further comprising
a gyroscope and an accelerometer in connection with the working tool module for sensing the positional and angular data of the working tool module,
wherein during set-up of the working tool towards the counterpart element or towards the desired surface, the controller is configured to adjust the angular alignment of the working tool module in relation to the arm or device housing so that
the working tool module is directed substantially orthogonally to the counterpart element or to the plane of the desired surface.

8. A method for controlling a painting or washing or spraying device or a working tool, comprising the steps of:
sensing the positional and angular data of a painting head or a working tool module by a gyroscope and an accelerometer, which are located in connection with the painting head or a working tool module,
adjusting the angular alignment of the painting head or a working tool module in relation to the device housing by a controller during movement of the device or working tool so that
directing the painting head or the working tool module substantially orthogonally to the plane of the treated or desired surface or to a counterpart element.
